(19) United States
(12) Patent Application Publication
(10) Pub. No.: US 2015/0147962 A1
(43) Pub. Date: May 28, 2015

(54) METHOD FOR PROCESSING DATA AND ELECTRONIC DEVICE THEREOF

(71) Applicant: Samsung Electronics Co., Ltd., Gyeonggi-do (KR)

(72) Inventors: Su-Young Park, Gyeonggi-do (KR); Hyun-Chul Choi, Seoul (KR); Sun-Min Hwang, Gyeonggi-do (KR)

(21) Appl. No.: 14/539,800

(22) Filed: Nov. 12, 2014

(30) Foreign Application Priority Data
Nov. 22, 2013 (KR) 10-2013-0142689

(51) Int. Cl. H04W 4/00; H04W 12/06

(52) U.S. Cl. CPC H04W 4/008; H04W 12/06
USPC 455/41.1; 455/41.2; 455/90.2

(57) ABSTRACT

Provided is a method of an electronic device. The method includes selecting first information included in a first program and second information included in a second program. The method also includes converting the selected first and second information according to a transmission mode of short range communication. The method further includes generating third and fourth information, respectively. The method includes transmitting the third and fourth information to an opposing electronic device using the short range communication.

### PRIORITY

The present application is related to and claims priority under 35 U.S.C. §119 to Application No. 10-2013-0142689 filed in the Korean Intellectual Property Office on Nov. 22, 2013, the contents of which are incorporated herein by reference.

### TECHNICAL FIELD

Various embodiments of the present disclosure relates generally to a method of transmitting and receiving data through short-range wireless communication and an electronic device therefor.

### BACKGROUND

Currently, due to developments of multimedia technology and circuit integration technology, an electronic device capable of using various multimedia functions becomes increasingly miniaturized and is used as a personal necessity. Moreover, since an electronic device provides not only a voice communication function through mobile communication but also various additional services such as data communication through the internet, video playback, audio playback, messenger, scheduling and alarm functions, various programs for using the functions are used in the electronic device and input schemes for using programs installed in the electronic device also become diversified. In addition, recently, as short-range communication technology of an electronic device is greatly developed, a method of transmitting and receiving information is being provided through short-range wireless communication.

### SUMMARY

To address the above-discussed deficiencies, it is a primary object to provide a method of selecting data in a short-range wireless communication environment, obtaining the data, and transmitting the obtained data to an opposing electronic device, and an electronic device therefor.

In a first example, an operating method of an electronic device includes selecting first information included in a first program and second information included in a second program. The method also includes converting the selected first and second information according to a transmission mode of short range communication and generating third and fourth information, respectively. The method further includes transmitting the third and fourth information to an opposing electronic device using the short range communication.

In a second example, an electronic device includes a memory comprising one or more pieces of obtained information. The electronic device also includes a communication module configured to transmit the obtained information. The electronic device further includes a processor configured to select first information included in a first program and second information included in a second program. The processor is also configured to convert the selected first and second information according to a transmission mode of short range communication and generating third and fourth information, respectively. The processor is further configured to transmit the third and fourth information to an opposing electronic device using the short range communication.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like: and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an example electronic device according to this disclosure;

FIG. 2 illustrates an example data processing module in an electronic device according to this disclosure;

FIGS. 3A and 3B illustrate an example operation for selecting data or transmitting data in an electronic device according to this disclosure;

FIGS. 4A through 4L illustrate example operations for selecting data to be transmitted in an electronic device according to this disclosure;

FIGS. 5A, 5B and 5C illustrate example operations in a transmitting and receiving mode in an electronic device according to this disclosure;

FIGS. 6A and 6B illustrate an example operation in the transmitting and receiving mode in an electronic device according to this disclosure;

FIGS. 7A and 7B illustrates an example flow diagram of an operation in the transmitting and receiving mode in an electronic device according to this disclosure; and

FIG. 8 illustrates an example block diagram of hardware according to this disclosure.

### DETAILED DESCRIPTION

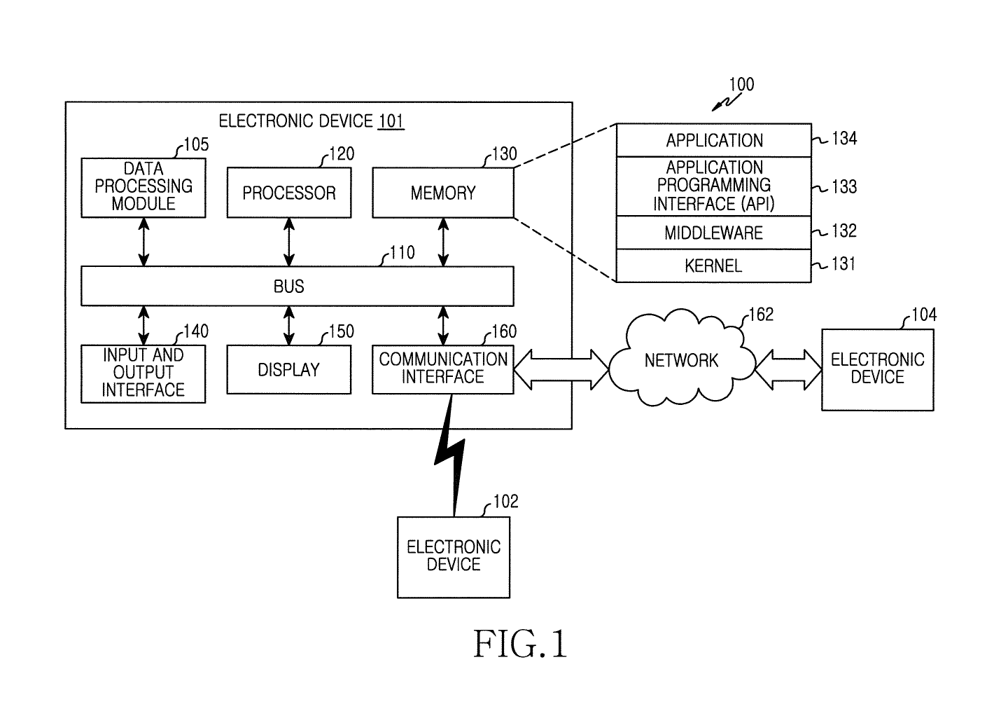

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Hereinafter, the present disclosure will be described with reference to the accompanying drawings. The present disclosure can be variously modified and can include various embodiments. However, specific embodiments are exemplarily illustrated in the drawings and detailed descriptions related thereto are provided. However, it should be understood that the particular embodiments are not intended to limit the present disclosure to specific forms, but rather the present disclosure is meant to cover all modification, equivalents, and alternatives which are included in the spirit and scope of the present disclosure. In the drawings, like reference numerals refer to like elements. In addition, in the following description, detailed descriptions of well-known functions or constructions will be omitted since they would obscure the disclosure in unnecessary detail. It is to be noted that in the following description, only parts required for understanding operations according to the present disclosure are described and description of the other parts will be omitted so as not to blur the subject matter of the present disclosure.

The term “include,” “comprise,” “including,” or “comprising” used herein indicates disclosed functions, operations, or existence of elements but does not exclude other functions, operations or elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

An electronic device includes a communication function. For example, the electronic devices can include at least one of smartphones, tablet personal computers (PCs), mobile phones, video telephones, electronic book readers, desktop PCs, laptop PCs, network computers, personal digital assistants (PDAs), portable multimedia players (PMPs), MP3 players, mobile medical devices, cameras, wearable devices (such as head-mounted-devices (HMDs) such as electronic glasses, electronic apparel, electronic bracelets, electronic necklaces, electronic appcessories, electronic tattoos, and smart watches).

Electronic devices can be smart home appliances having communication functions. The smart home appliances can include at least one of, for example, TVs, DVD players, audios, refrigerators, air conditioners, cleaners, ovens, microwave ovens, washing machines, air cleaners, set-top boxes, TV boxes (such as Samsung HomeSync™, Apple TV™, or Google TV™), game consoles, electronic dictionaries, electronic keys, camcorders, and electronic picture frames.

Electronic devices can include at least one of medical devices (such as magnetic resonance angiography (MRA), magnetic resonance imaging (MRI), computed tomography (CT), scanners, and ultrasonic devices), navigation devices, global positioning system (GPS) receivers, event data recorders (EDRs), flight data recorders (FDRs), vehicle infotainment devices, electronic equipment for vessels (such as navigation systems and gyrocompasses), avionics, and security devices.

Electronic devices can also include at least one of parts of furniture or buildings/structures having communication functions, electronic boards, electronic signature receiving devices, projectors, and measuring instruments (such as water meters, electricity meters, gas meters, and wave meters). Electronic devices can be one or more combinations of the above-mentioned devices. Furthermore, electronic devices can be flexible devices. In addition, it would be obvious to those skilled in the art that electronic devices according to this disclosure are not limited to the above-mentioned devices. Hereinafter, electronic devices will be described with reference to the accompanying drawings. The term “user” used herein can refer to a person who uses an electronic device or can refer to a device (such as an artificial electronic device) that uses an electronic device.

FIG. 1 illustrates an example block diagram of a system 100 including an electronic device 101 according to this disclosure.

Referring to FIG. 1, the electronic device 101 includes a data processing module 105, a bus 110, a processor 120, a memory 130, an input and output interface 140, a display module 150, or a communication interface 160.

The data processing module 105 selects first information included in a first program and second information included in a second program, creates third and fourth information by respectively performing conversion on the selected first and second information according to a transmission mode of short-range communication (such as short-range wireless communication), and controls the third and fourth information so as to be transmitted to an opposing electronic device by using the short-range communication.

The data processing module 150 creates the third and fourth information by applying one or more of conditions of a name change, a data format change, and a command structure change to one or more pieces of the first and second information. When detecting a designated operation of inputting to the electronic device, the data processing module 105 controls so that the third and fourth information is transmitted. The data processing module 105 can control so that the third and fourth information is transmitted through one or more of near field communication (NFC), Bluetooth (BT) communication, Wi-Fi communication, radio frequency identification (RFID) communication, Infrared data association (IrDA) communication, WiBro communication, and ZigBee communication. When one or more pieces of the first and second information is security-applied, the data processing module 105 performs an authentication process, obtains the security-applied information according to a result of the authentication process, and/or controls so as to create fifth information secured on the basis of the obtained security-applied information. The data processing module 105 can control so that the first or second information includes one or more among web page address data, image data, sound data, save data of a program, text data, identification code of the first or second program, and link data linked to one or more contents. When the first or second information is information on a date and time, the data processing module 105 provides commands for changing date and time of the opposing electronic device that receives information on the data and time.

The bus 110 connects the above-described elements and delivers communication (such as a control message) between the above-described elements.

The processor 120 receives commands from other elements (such as the memory 130, the input and output interface 140, the display module 150, the communication interface 160, and the like) through, for example, the bus 110, interprets the received commands, and executes operations or data processing according to the interpreted commands.

The memory 130 (such as the memory 125) stores commands or data received from or created by the processor 120 or other elements (such as the input and output interface 140, the display module 150, the communication interface 160, and the like). The memory 130 includes programming modules, for example, a kernel 131, middleware 132, an application programming interface (API) 133, or an application 134. Each of the above-described programming modules can be configured of software, firmware, hardware, or a combination of at least two thereof.

The kernel 131 controls or manages system resources (such as the bus 110, the processor 120 or the memory 130. and the like) used for executing operations or functions implemented in the rest of the programming modules, for example, the middleware 132, the API 133 or the application 134. In addition, the kernel 131 provides an interface capable of accessing an individual element of the electronic device 101 from the middleware 132, the API 133, or the application 134, and controlling or managing it.

The middleware 132 plays a relay role of allowing the API 133 or the application 134 to communicate with the kernel 131 and transmit and receive data. In addition, in relation to a job request received from the application(s) 134, the middleware 132 performs load balancing on the job request by using a method of assigning priority that uses a system resource (such as the bus 110, the processor 120 or the memory 130, and the like) to at least one selected from among the application(s) 134.

The API 133 is an interface capable of allowing the application 134 to control a function provided by from the kernel 131 or the middleware 132, and includes at least one interface or function for, for example, a file control, a window control, an image processing, or text control.

The input and output interface 140, for example, receives commands or data from the user and deliver them to the processor 120 or the memory 130 through the bus 110. The display module 150 can display images, videos, or data to the user. In an embodiment, when the display module 150 is provided with a touch screen panel, the commands are inputted through gestures of touching or hovering over (such as an indirect touch input) the display module 150.

The communication interface 160 connects communication between the electronic device 101 and an auxiliary electronic device 102, an electronic device 104, or a server. The communication interface 160 supports a predetermined short-range communication protocol (such as Wi-Fi, BT, NFC or a predetermined network communication 162 (such as Internet, LAN, WAN, telecommunication network, cellular network, satellite network, or plain old telephone service (POTS), and the like)). Each of the electronic devices 102 and 104 can be identical to (such as of a same type) or different from (such as of a different type) the electronic device 101.

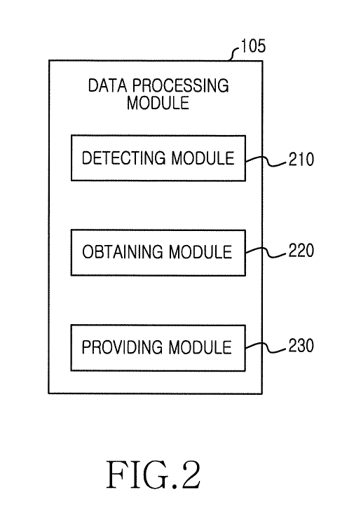

FIG. 2 illustrates an example data processing module 105 in the electronic device 101 according to this disclosure.

Referring to FIG. 2, the data processing module 105 includes one or more of a detecting module 210, an obtaining module 220, and a providing module 230. Each module described below can represent hardware physically configured to perform operations described herein or can be software configured with logical data configured to perform operations to be described herein.

The detecting module 210 detects a designated operation of calling a transmission and reception mode for transmitting and receiving data in the electronic device 101. When data of the electronic device 101 is transmitted to an opposing electronic device 102 through NFC communication and a tagging operation that the electronic device 101 is located to be within a designated distance from the opposing electronic device 102 is detected, the transmission and reception mode is called for selecting data desired to be transmitted to the opposing electronic device 102.

The obtaining module 220 selects one or more programs and/or program information included in the electronic device 101 through the transmission and reception mode of the electronic device 101. The electronic device 101 displays a screen configuration for the one or more programs and/or program information included in the electronic device 101 on the display module 150 through the transmission and reception mode. The electronic device 101 obtains the entirety of or a part of information displayed on the display module 150. When the obtained information is security-applied, the electronic device 101 performs the authentication process for confirming to have authority to copy, move, modify, or delete the security-applied information. The electronic device 101 applies new security to the security-applied information obtained by performing the authentication process.

The providing module 220 performs a designated operation on the obtained information (such as the security-applied information) in the electronic device 101 and transmits the obtained information to the opposing electronic device 102. In an embodiment, when the detecting module in the electronic device 101 detects a tagging operation, calls the transmission and reception mode, and detects another tagging operation again, information obtained in the transmission and reception mode is transmitted to the opposing electronic device 102.

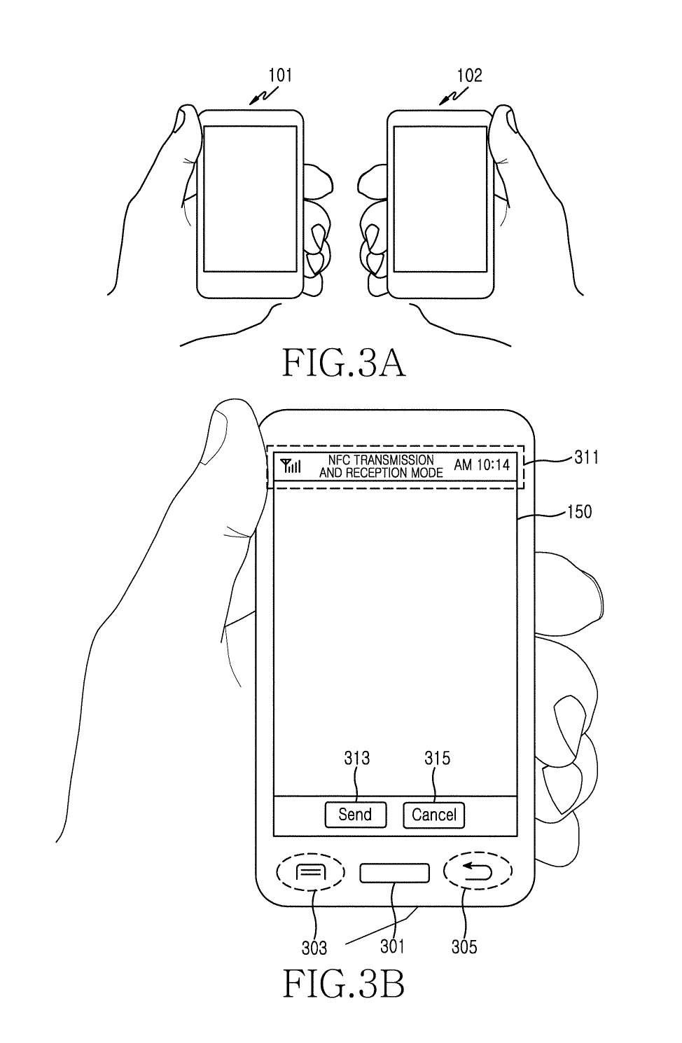

FIGS. 3A and 3B illustrates an example operation for selecting or transmitting data in the electronic device 101 according to this disclosure.

The electronic device 101 transmits and receives data selected by one or more programs being executed in the electronic device 101 to and from an opposing electronic device (such as the electronic device 102) in a short-range wireless communication scheme such as NFC wireless communication. Hereinafter, even though the electronic device 101 and the opposing electronic device (such as the electronic device 102) are described to transmit and receive data to and from each other through an NFC communication module (the NFC communication scheme), it is obvious that the communication scheme is not limited to the NFC communication and various communication schemes such as BT, Wi-FI, RFID, IrDA, WiBro, and ZigBee communication can be employed.

Referring to FIG. 3A, when the data is transmitted through the NFC communication, the electronic device 101 uses, as a switching operation of transmitting and receiving data or preparing for data transmission and reception, an operation of getting (such as tagging) two or more electronic devices (such as electronic devices 101 and 102) including the NFC modules closer than a designated distance. The electronic device 101 enters a mode (hereinafter, a transmission and reception mode 311 or an NFC transmission and reception mode 311) in which data to be transmitted to the opposing electronic device 102 is selected at the time of being tagged to the opposing electronic device 102, and begin to transmit data selected by the tagging operation to the opposing electronic device 102, after selecting the data to be transmitted to the opposing electronic device 102 in the transmission and reception mode 311.

When not able to transmit the selected data to the opposing electronic device 102 through NFC communication, the electronic device 101 determines one or more network communications (such as wireless communication) connected or connectable to the opposing electronic device 102, and transmits the selected data through the connected wireless communication.

In an embodiment, for the NFC communication, even though it is described that the electronic device 101 uses the tagging operation as a switching operation of transmitting and receiving data or preparing for data transmission and reception, the switching operation is not limited hereto and an operation of transmitting data through one or more network communications (such as wireless communication) connected or connectable to the opposing electronic device 102 can be used as the switching operation.

Referring to FIG. 3B, the electronic device 101 includes a button (such as a button 301 which is one of input devices through which commands can be input by a click on the front surface, side surfaces (such as top side surface, bottom side surface, left side surface, or right side surface), or rear surface, a touch button (such as a touch button 303 or a touch button 305) through which commands can be input by a touch at a fixed position, and one or more speakers through which sound can be output. The electronic device 101 can include at least one microphone capable of receiving external sound at a position where the microphone is exposed externally and a sound can be input. The electronic device 101 includes a display module 150 on a front surface unit and display user interface (UI) operations of the electronic device 101 through the display module 150.

The electronic device 101 can include the button (such as the button 301) or the touch button (such as the touch button 303 or the touch button 305) at an identical position or different positions.

The electronic device 101 selects the entirety of or a part of data from one or more programs to be transmitted and received therein through the transmission and reception mode 311. When entering the transmission and reception mode 311, the electronic device 101 displays a state of the transmission and reception mode 311 through the display module 150. The electronic device 101 displays a mark 311 (hereinafter, the transmission and reception mode 311) for confirming the transmission and reception mode 311 on a predetermined area of the display module 150, and display an icon 313 for transmitting the selected data on another predetermined area, or an icon 315 for canceling the selection for the selected data or terminating the transmission and reception mode 311. The electronic device 101 displays a UI for operation states of one or more programs in the transmission and reception mode 311 on the display module 150. The electronic device 101 selects data to be transmitted to the opposing electronic device 102 with reference to the operation states of the displayed programs. The electronic device 101 switches an operation state of the program (such as the first program) displayed on the display module 150 in the transmission and reception mode 311 into another operation state of another program (such as the second program). The electronic device 101 stores the data selected by the first program as transmission data for the first program in a designated area of the transmission and reception mode 311 and selects data to be transmitted to the opposing electronic device 102 from the switched second program. The electronic device 101 stores data selected by the second program as transmission data for the second program. When obtaining the entirety of or a part of data of each program selected by the transmission and reception program, the electronic device 101 directly obtains data selected by the program being displayed on the display module 150 through the transmission and reception mode 311 (such as one or more programs performing the transmission and reception mode 311). In an embodiment, the electronic device 101 can obtain data in one or more programs pre-stored in the memory 130 of the electronic device 101 through the transmission and reception mode 311 (such as one or more programs performing the transmission and reception mode 311), and can configure a database by classifying each program and data included in the programs.

When selecting data to be transmitted to the opposing electronic device 102 in the transmission and reception mode 311, the electronic device 101 converts the selected data into data of a designated format in the transmission and reception mode 311 or regenerate the selected data. In an embodiment, the one or more programs stored in the electronic device 101 can be different in a data processing scheme according to a style of each program developer. The electronic device 101 configures data included in each program as standardized data according to a designated scheme. When transmitting the standardized data to the opposing electronic device 101, data transmitted to the opposing electronic device 102 processes through a transmission and reception program (such as software or a software module capable of performing the transmission and reception mode 311) of the opposing electronic device 102.

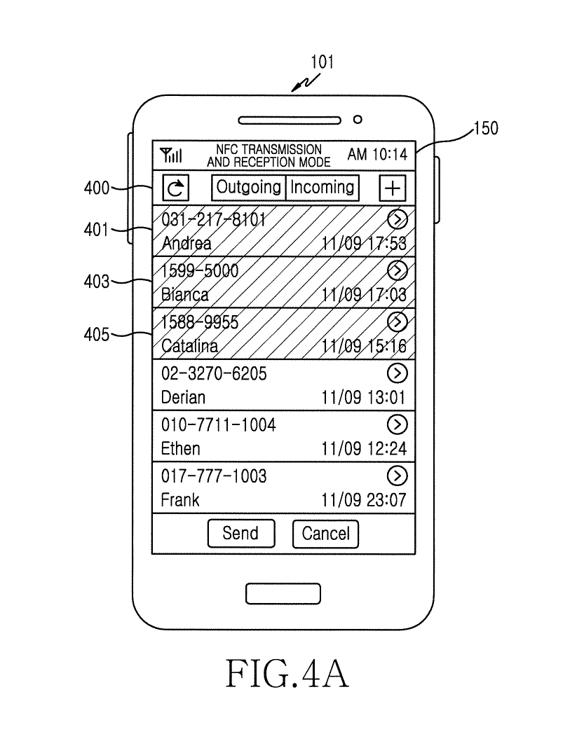

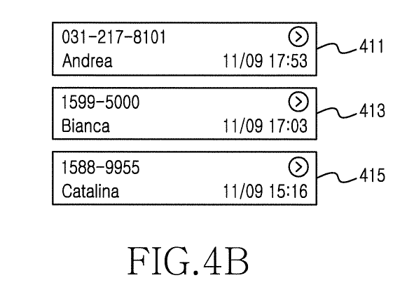

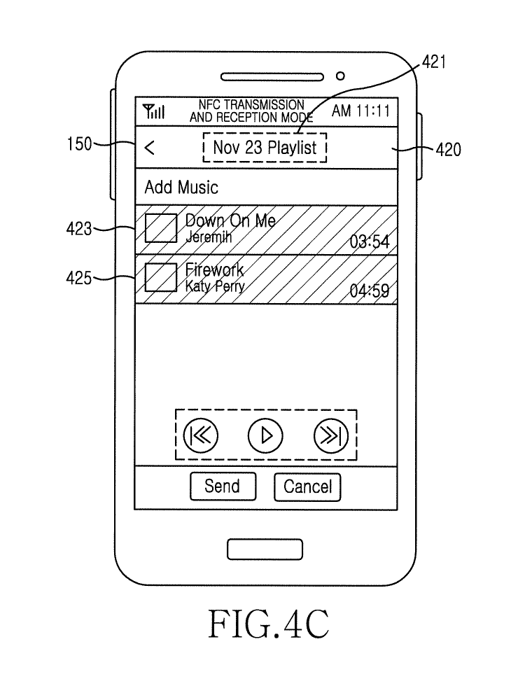

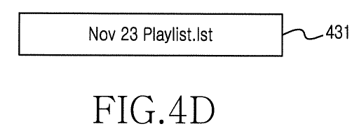

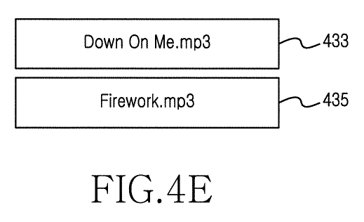

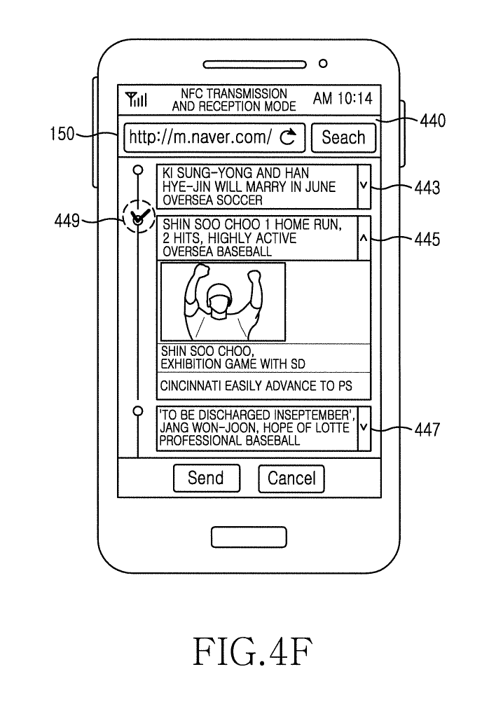

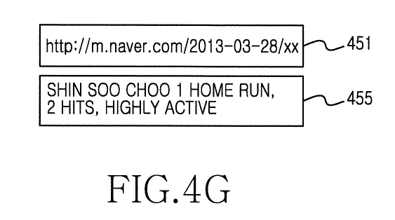

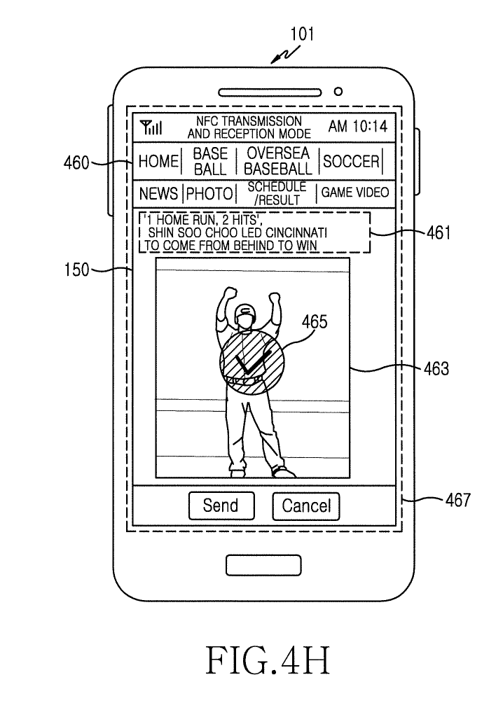

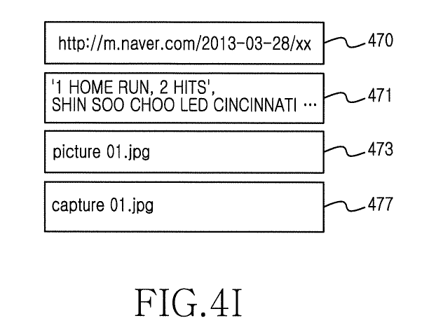

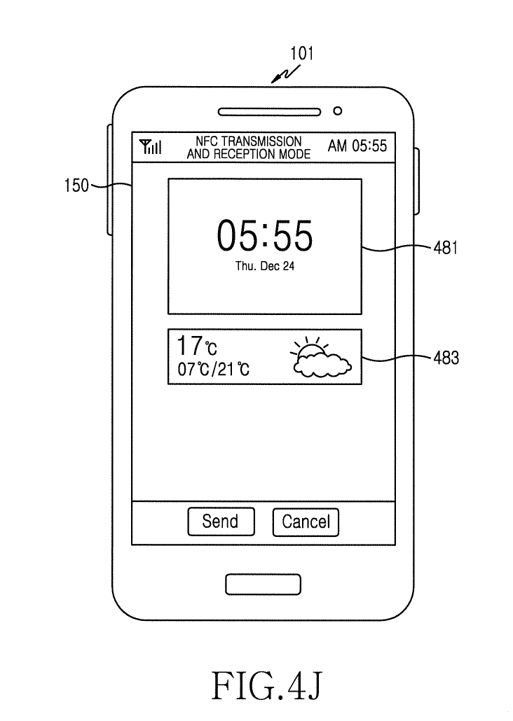

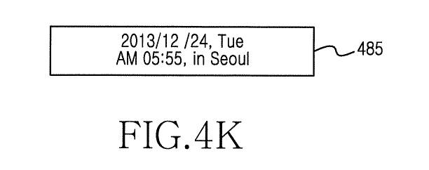

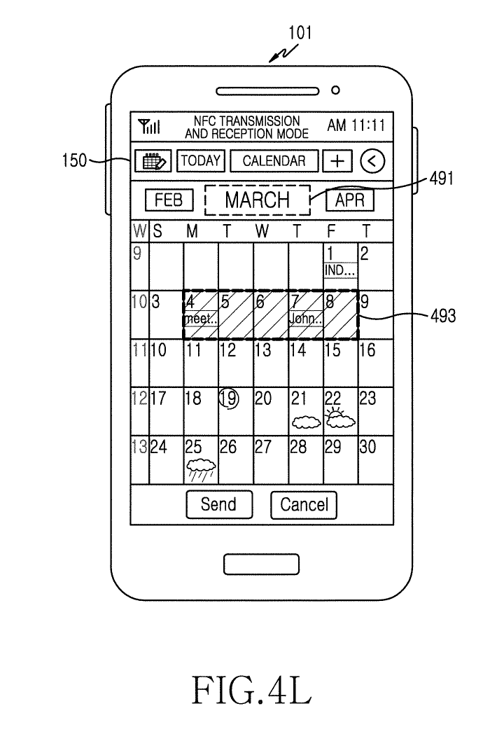

FIGS. 4A through 4L illustrate example operations for selecting data to be transmitted in an electronic device according to this disclosure.

Referring to FIG. 4A, the electronic device 101 displays a program including data desired to be transmitted and received through the transmission and reception mode on the display module 150. The electronic device 101 selects one or more pieces of information (such as call information) to be transmitted in a scheme designated by the transmission and reception program from among operation state information (such as a call list 400) of a displayed program. According to an embodiment, the electronic device 101 selects (such as call information 401, call information 403, call information 405) one or more pieces of outgoing call information (such as a case of an outgoing call from the electronic device 101) or incoming call information (such as a case of an incoming call to the electronic device 101), which is to be transmitted to the opposing electronic device 102, from among the call list 400 displayed on the display module 150.

Referring to FIG. 4B, the electronic device 101 obtains one or more pieces of call information (such as the call information 401, the call information 403, the call information 405) selected from the call list 400 through the transmission and reception mode 311 as data according to the designated scheme in the transmission and reception mode 311. The above-described designated scheme can be a scheme that converts data in a type, which is processed in a call list program of the electronic device 101, into data in a type that the electronic device 101 and the opposing electronic device 102 typically process, or a scheme that converts data in a type corresponding to the NFC communication specification when the data is transmitted to the opposing electronic device 102 in the NFC communication. The electronic device 101 can obtain ‘data 411 in the call list 400’, ‘data 413 in the call list 400’, ‘data 415 in the call list 400’ in a type designated in the transmission and reception mode 311, which respectively correspond to call information 401, call information 403, call information 405 selected from the call list 400 displayed on the display module 150 in FIG. 4A. The electronic device 101 performs a tagging operation to the opposing electronic device 102 and transmits the obtained data to the opposing electronic device 102 in NFC communication.

Referring to FIG. 4C, the electronic device 101 selects one or more pieces of information (such as music information) to be transmitted from operation state information (such as music playback information 420) of a program including data to be transmitted through the transmission and reception mode 311 in a method designated in the transmission and reception program. In an embodiment, the electronic device 101 selects one or more play lists (such as ‘Nov 23 playlist’ 421) or one or more pieces of music information desired to be transmitted to the opposing electronic device 102 from the music playback information 420 being displayed on the display module 150.

Referring to FIG. 4D, the electronic device 101 obtains the one or more play lists or one or more pieces of music information which are selected from the music playback information 420 through the transmission and reception mode 311 as data according to a designated scheme of the transmission and reception mode 311. According to an embodiment, when ‘Nov 23 Playlist’ 421 displayed on the display module 150 in FIG. 4C is selected, the electronic device 101 obtains, as corresponding play list data, a play list 431 of the music playback information 420 in a type designated in the transmission and reception mode 311.

Referring to FIG. 4E, when ‘music information (such as information on music titled ‘down on me’) 423′ and ‘music information (such as information on music titled ‘firework’) 425′ displayed on the display module 150 in FIG. 4C are selected, the electronic device 101 obtains corresponding music data (such as ‘down on me’ music file 433 and ‘firework’ music file 435). The electronic device 101 performs a tagging operation to the opposing electronic device 102 and transmits the obtained data to the opposing electronic device 102 in NFC communication.

Referring to FIG. 4F, the electronic device 101 selects, in a designated scheme in a transmitting and receiving program, one or more pieces of information (such as an article) desired to be transmitted from operation state information (such as an internet page 440) of a program including data to be transmitted and received through the transmission and reception mode 311. In an embodiment, the electronic device 101 selects portion 449 one or more pieces of article information (such as article information 443, 445, or 447) from the internet page 440 being displayed on the display module 150.

Referring to FIG. 4G, the electronic device 101 obtains one or more pieces of selected portion 449 article information (such as article information 445) from address information 451 on the internet page 440 being displayed on the display module and/or a plurality of pieces of article information (such as article information 443, article information 445, article information 447) being displayed on the display module 150 through the transmission and reception mode 311. The electronic device 101 performs a tagging operation to the opposing electronic device 102 and transmits the obtained data (such as obtained data 451 or 455) to the opposing electronic device 102 in NFC communication.

Referring to FIG. 4H, the electronic device 101 can select one or more pieces of text, image, and sound information included in the page being displayed on the display module 150 of the electronic device 101, and can capture a screen configuration being displayed on the display module 150. In an embodiment, the electronic device 101 selects text ‘one home run, two hits, Shin Soo Choo led Cincinnati to come from behind to win’ 461 included in an internet page 460 being displayed on the display module 150 through the transmission and reception mode 311, and selects an image 463 being displayed on the display module 150. When one or more contents (such as objects visually configured to display various information provided as image information, save file information, and sound information) being displayed on the display module 150 are selected, the electronic device displays a mark 465 for representing the selected area. In addition, the electronic device 101 performs a capture operation designated in the electronic device 101 on a screen configuration being displayed on the display module 150 and obtains the captured image 467.

Referring to FIG. 4I, the electronic device 101 can obtain one or more pieces of information among address information 470 on the internet page 460 being displayed on the display module 150, article information being displayed on the display module 150 or information 471 on a designated text area selected from text information being displayed, one or more pieces of image information 473 selected from among images being displayed on the display module 150, and one or more pieces of image information 477 that a screen configuration being displayed on the display module 150 is captured. The electronic device 101 performs a tagging operation to the opposing electronic device 102 and transmits the obtained data to the opposing electronic device 102 in NFC communication.

Referring to FIG. 4J, the electronic device 101 selects content included in one or more programs displayed on the display module 150 through the transmission and reception mode 311. In an embodiment, the electronic device 101 selects one or more pieces of information (such as date and time information 481) from date and time information 481 and weather information 483 included in a home screen program displayed on the display module 150 of the electronic device 101 through the transmission and reception mode.

Referring to FIG. 4K, the electronic device 101 obtains date and time information 481 selected through the transmission and reception mode 311. In obtaining the information 481 selected through the transmission and reception mode 311, the electronic device 101 can obtain date and time information 485 regenerated by applying the transmission and reception mode 311 of the first electronic device 101 and the opposing electronic device 102 to which the electronic device 101 transmits data or applying instructions or codes reserved with one or more programs capable of using date and time information 481 in the opposing electronic device 102 that receives the date and time information 481 obtained by the electronic device 101. The electronic device 101 can include instructions controlling on as to re-set date and time information of the opposing electronic device 102 that receives the regenerated data and time information 485 in an operation of regenerating the information 481 selected in the electronic device 101. The electronic device 101 performs a tagging operation to the opposing electronic device 102 and transmits the obtained data to the opposing electronic device 102 in NFC communication.

Referring to FIG. 4L, the electronic device 101 selects content included in one or more programs displayed on the display module 150 through the transmission and reception mode 311. In an embodiment, the electronic device 101 selects monthly management information and/or one or more pieces of daily management information from schedule management information in a schedule management program displayed on the display module 150 of the electronic device 101. The electronic device 101 can select one month management information on ‘Mar. 2013’ 491 from a calendar screen configuration (such as schedule of Mar. 2013) of a schedule management program, or one or more pieces of daily management information on days ‘4 to 8’ 493 from the calendar screen configuration (such as schedule of Mar. 2013). The electronic device 101 obtains schedule information corresponding to one month management information on ‘Mar. 2013’ 491 and/or management information on days ‘4 to 8’ 493 selected through the transmission and reception mode 311. In obtaining the one month management information on ‘Mar. 2013’ 491 and/or the management information on days ‘4 to 8’ 493 selected through the transmission and reception mode 311, the electronic device 101 obtains one month management information on ‘Mar. 2013’ and/or management information on days ‘4 to 8’ regenerated by applying the transmission and reception mode 311 of the first electronic device 101 and the opposing electronic device 102 to which the electronic device 101 transmits data or applying instructions or codes reserved with one or more programs capable of using date and time information 481 in the opposing electronic device 102 that receives the date and time information 481 obtained by the electronic device 101. The electronic device 101 includes instructions for controlling so as to re-set information on the schedule management program of the opposing electronic device 102 that receives corresponding information in an operation of regenerating management information on one month management information on ‘Mar. 2013’ and/or management information on days ‘4 to 8’. Furthermore, in obtaining the regenerated one month management information on ‘Mar. 2013’ and/or management information on days ‘4 to 8’, the electronic device 101 includes identification code of the schedule management program of the electronic device 101. The electronic device 101 performs a tagging operation to the opposing electronic device 102 and transmits the obtained data to the opposing electronic device 102 in NFC communication.

The opposing electronic device 102 that receives the regenerated one month management information on ‘Mar. 2013’ and/or management information on days ‘4 to 8’ from the electronic device 101 discriminates the received management information from one or more pieces of scheduling information included in the schedule management program of the opposing electronic device 102 through an identification code of the electronic device 101 included in the received information. Here, even though it is described that the identification code is added to the schedule management program, the identification code can be an identification code of the electronic device 101 or an identification code of a corresponding program, when the entirety of or a part of information of another program is obtained.

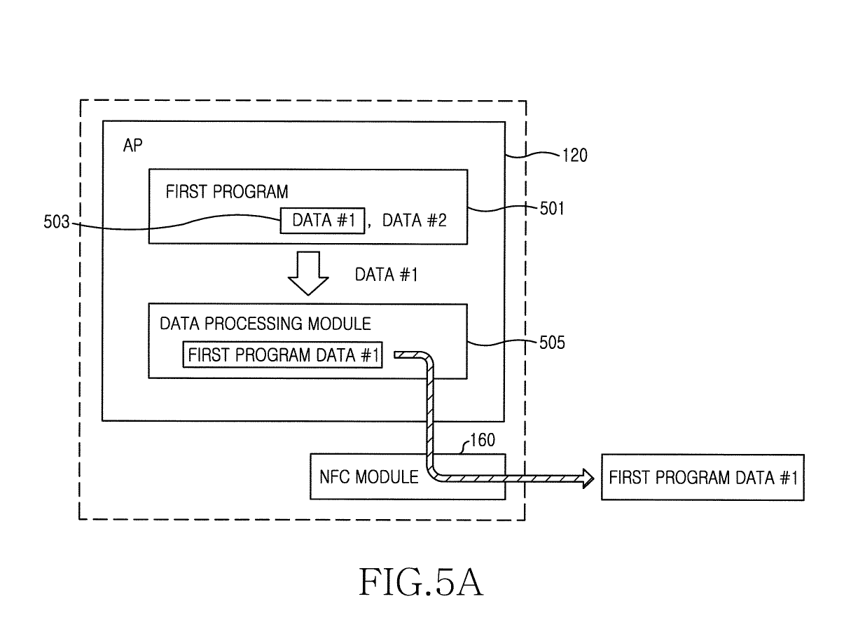

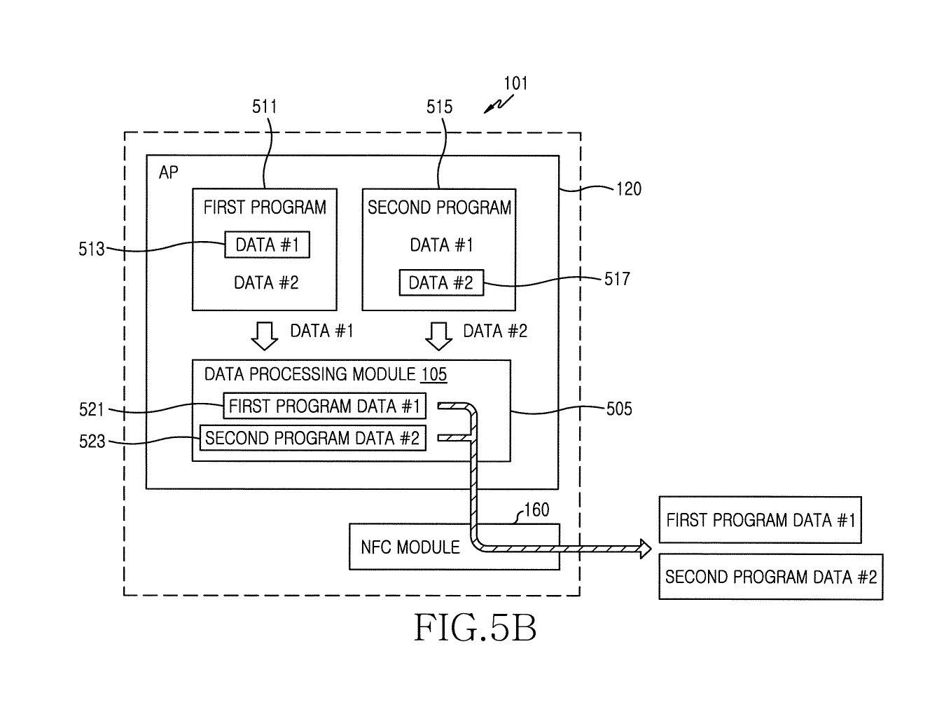

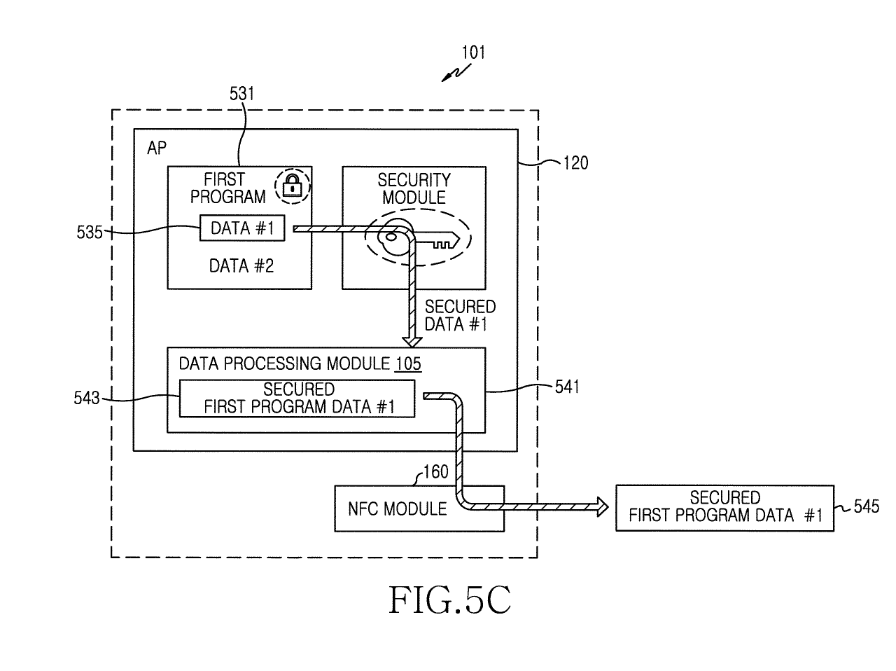

FIGS. 5A, 5B and 5C illustrate example operations of the transmission and reception mode 311 in an electronic device 101 according to this disclosure.

The electronic device 101 selects and obtains one or more contents included in one or more programs in operation in the electronic device 101 through the transmission and reception mode 311, and transmits them to the opposing electronic device 102 in a designated communication scheme (such as NFC communication scheme). Here, the transmission and reception mode is a function of one or more programs included in the electronic device 101 controlling the data processing module 105. In the description below, various embodiments can be processed through one or more processors included in the electronic device 101.

Referring to FIG. 5A, the electronic device 101 selects one or more pieces of information selected in the electronic device 101 and transmits the selected information to the opposing electronic device 102 through network communication (such as NFC communication). In an embodiment, the electronic device 101 can call the transmission and reception mode 311 of the electronic device 101 by performing an operation of getting the NFC module 160 in the electronic device 101 close to an NFC module of the opposing electronic device 102 to which the electronic device 101 tries to transmit one or more pieces of selected information, or by performing a designated operation of calling the transmission and reception mode 311 of the electronic device 101. The electronic device 101 selects one or more pieces of information (such as data #1 503) included in a first program 50) through the transmission and reception mode 311. The data processing module 105 receives the data #1 503 selected by the first program 501 and regenerates the obtained data into first program data #1 507 configured with instructions typically used in the electronic device 101 and the opposing electronic device 102 to which data obtained by the data processing module is transmitted. When transmitting selected data #1 501 of the first program 501 through the network communication (such as NFC communication), the electronic device 101 configures the first program data #1 507 with instructions corresponding to communication specification of NFC communication. The electronic device 101 stores the regenerated first program data #1 507 in a designated area 505 where the data processing module 105 is controllable or the memory 130 of the electronic device 101. The electronic device 101 performs designated operations on the electronic device 101 or repetitively perform an operation of getting the NFC module 160 of the electronic device 101 close to the NFC module of the opposing electronic device 102 and transmits the first program data #1 507 of the electronic device 101 to the opposing electronic device 102.

Referring FIG. 5B, the electronic device 101 selects one or more pieces of information selected in the electronic device 101 and transmits them to the opposing electronic device 102 through the network communication (such as NFC communication). In an embodiment, the electronic device 101 performs a designated operation of calling the transmission and reception mode 311 and calls the transmission and reception mode 311 of the electronic device 101. The electronic device 101 selects one or more pieces of information (such as data #) 513 of a first program 511 or data #2517 of a second program 515) through the transmission and reception mode 311. For example, the data processing module 105 receives data #1 513 selected in the first program 511 and regenerates the obtained data into first program data #1 521 configured with instructions typically used in the electronic device 101 and the opponent electrode device 102 to which data obtained by the data processing module 105 is transmitted. In addition, the electronic device 101 selects one or more pieces of information (such as data #2 517 of a second program 515) through the transmission and reception mode 311. The data processing module 105 receives data #2 517 selected in the second program 515 and regenerates the obtained data into second program data #2 523 configured with instructions typically used in the electronic device 101 and the opposing electronic device 102 to which data obtained by the data processing module 105 is transmitted.

When regenerating the data #1 513 selected in the first program 511 and the data #2 517 selected in the second program 515 into first program data #1 521 and second program data #2 523, the electronic device 101 regenerates the first program data #1 521 at the time of obtaining data #1 513 in the first program 511 and regenerates the second program data #2 523 at the time of obtaining the data #2 527 in the second program 515. Alternatively, the first program 511 obtains the data #1 513 and the second program 515 obtains the data #2 517, and then the program data #1 521 and the second program data #2 523 are regenerated.

When obtaining the data #1 513 selected in the first program 511 and the data #2 517 selected in the second program 515, the electronic device 101 can obtain pre-regenerated data included in the database of the electronic device 101. In an embodiment, the electronic device 101 regenerates one or more programs included in the electronic device 101 and information included in the programs by using a data format or instructions corresponding to one or more communication specifications that can process in the transmission and reception mode and store them in the database through the transmission and reception mode 311. The electronic device 101 can obtain the pre-regenerated first program data #1 521 from the database when the data #1 513 of the first program 511 is selected through the transmission and reception mode 311 and can obtain the pre-regenerated second program data #2 523 from the database when the data #2 517 of the second program 515 is selected.

The electronic device 101 performs a designated operation (such as transmitting icon selection) and transmits the first program data #1 521 and the second program data #2 523 in the electronic device 101 to the opposing electronic device 102. The opposing electronic device 102 that receives the first program data #1 521 and the second program data #2 523 transmitted from the electronic device 101 processes the first program data #1 521 and the second program data #2 523 received through a transmission and reception mode (such as a mode at least similar to the transmission and reception mode 311 of the electronic device 101) of the opposing electronic device 102, one or more functions corresponding to a transmission and reception mode, or one or more programs capable of performing a transmission and reception mode.

Referring to FIG. 5C, the electronic device 101 transmits one or more data to which security included on the electronic device 101 is applied through the transmission and reception mode 311 to the opposing electronic device 102. In an embodiment, the electronic device 101 selects one or more pieces of information (such as the data #1 535) to which security is applied included in the first program 531 through the transmission and reception mode 311. The electronic device 101 can perform an authentication process on movement, copy, and change of the data #1 535 to which security is applied in order to transmit the selected data #1 535 through the transmission and reception mode to a designated area 541 of the data processing module 105. The electronic device 101 regenerates the obtained data #1 535 into secured first program data #1 543 configured with instructions typically used in the opposing electronic device 102 that receives the secured data #1 535 according to a designated security authority. When trying to transmit the selected data #1 of the first program 531 in network communication (such as NFC communication), the electronic device 101 generates the first program data #1 543 configured with commands corresponding to communication specification of the NFC communication and secured with the existing security setting or new security setting. The electronic device 101 stores the regenerated secured first program data #1 543 in a designated area 541 controllable by the data processing module or in the memory 130 of the electronic device 101.

The electronic device 101 can further include data #2 of the second program secured though the transmission and reception mode 311 and/or data #3 of a third program, which is not secured. The electronic device 101 can reconfigure the obtained secured first program data #1 543, secured second program data #2 and non-secured third program data #3 with one or more data. The electronic device 101 performs an operation designated in the electronic device 101 and transmits, to the opposing electronic device 102, the secured first program data #1 543, the secured second program data #2 and the non-secured third program data #3.

The opposing electronic device 102 that receives the secured first program data #1 543, the secured second program data #2 and the non-secured third program data #3 transmitted by the electronic device 101 performs an authentication process on the secured first program data #1 545 and/or the secured second program data #2 through a transmission and reception mode of the opposing electronic device 102 (such as at least a similar mode to the transmission and reception mode 311 of the electronic device), or one or more programs capable of performing one or more functions corresponding to the transmission and reception mode or the transmission and reception mode. The opposing electronic device 102 controls so as to process the data (such as the first program data #1 545) passing through the authentication process.

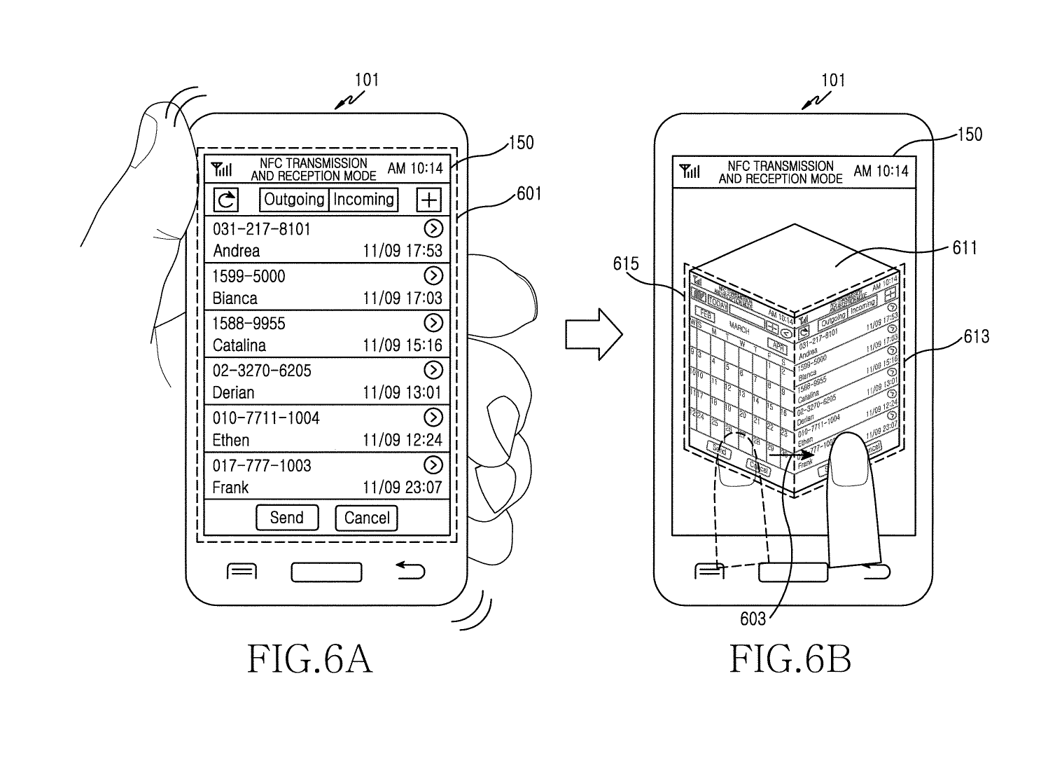

FIGS. 6A and 6B illustrate example operations of the transmission and reception 311 in an electronic device 101 according to this disclosure.

When displaying various contents included in one or more programs through the transmission and reception mode 311, the electronic device 101 switches programs of the electronic device 101 or contents included in the programs and provides various methods of displaying them on the display module 150.

Referring to FIG. 6A, the electronic device 101 performs an operation (such as an operation of shaking the electronic device 101) designated for changing a program being displayed on the display module 150 in a state where a call list 601 of the electronic device 101 is being displayed on the display module 150 through the transmission and reception mode. When detecting the operation of shaking the electronic device 101, the electronic device 101 displays two or more programs in order to switch one or more programs being displayed on the display module 150 through the transmission and reception mode 311.

Referring to FIG. 6B, when displaying the transmission and reception mode 311 on the display module 150, the electronic device 101 applies visual effects through which one or more programs and/or one or more contents included in the programs are displayed. In an embodiment, when displaying a screen configuration for one or more programs or one or more contents included in the programs besides a program screen configuration being displayed on the display module 150 in the middle of selecting information desired to be transmitted to the opposing electronic device 102 through the transmission and reception mode 311, the electronic device 101 displays each of two or more programs or contents included in the programs on a designate surface of hexahedron realized on a designated area of the display module 150. For example, with reference to FIG. 6A, the electronic device 101 displays the call list 613 being displayed on the display module 150 through the existing transmission and reception mode 311 on one designated surface of a polyhedral (such as hexahedral) solid FIG. 611 displayed on the display module 150 through the transmission and reception mode 311, and displays, on another designated surface thereof, a screen configuration 615 of a schedule management program being operated in the background of the electronic device 101. In an embodiment, the electronic device 101 checks one or more programs and/or a screen configuration of the programs displayed on the polyhedron by performing a designated operation (such as a touch, drag, and release operation) with an input unit (such as a part of a finger) on a predetermined area of the polyhedron that a screen configuration of one or more programs is displayed and edits information to be transmitted to the opposing electronic device 102 by selecting one or more programs and/or a screen configuration.

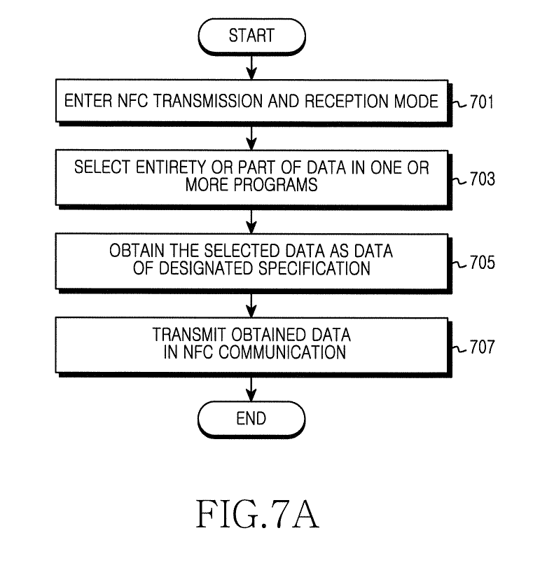

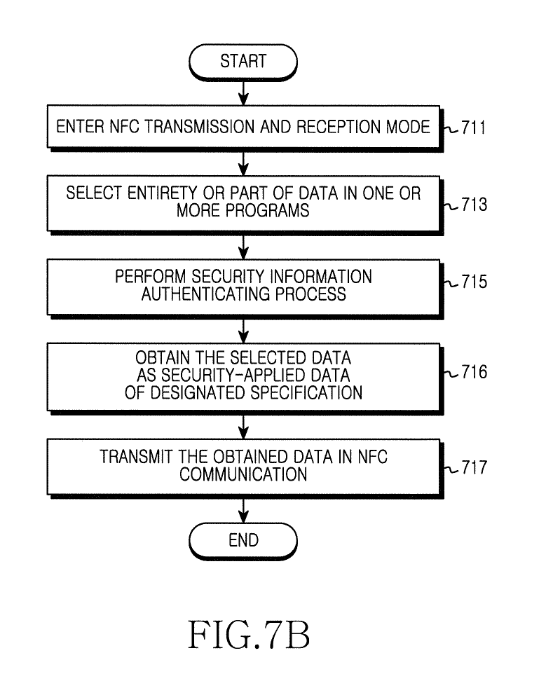

FIGS. 7A and 7B illustrate flowcharts of example operations of the transmission and reception mode 311 in an electronic device 101 according to this disclosure.

The electronic device 101 selects the entirety of or a part of information included in one or more programs included in the electronic device 101 and transmit them to the opposing electronic device 102.

As shown in FIG. 7A, in operation 701, the electronic device 101 performs a designated operation and call the transmission and reception mode 311 of the electronic device 101. The electronic device 101 selects one or more programs and/or the entirety of or a part of information in a screen configuration of the program through the transmission and reception mode 311, and obtains the selected information. The electronic device 101 transmits the selected information to the opposing electronic device 103 in the transmission and reception mode 311 through network communication. In an embodiment, the designated operation of calling the transmission and reception mode in the electronic device 101 can be a tagging operation of getting the NFC module of the electronic device 101 to be close to the NFC module of the opposing electronic device 102 within a designated distance.

In operation 703, the electronic device 101 selects information to be transmitted to the opposing electronic device 102 from information displayed on the display module 150 of the electronic device 101 through the transmission and reception mode 311. The electronic device 101 selects one or more pieces of information among one or more image data, text data, sound data, link data linked to other contents, and program save data displayed on the display module 150 of the electronic device 101 through the transmission and reception mode 311.

In operation 705, the electronic device 101 obtains information selected in the transmission and reception mode 311. In obtaining the selected data, the electronic device 101 can regenerate the obtained data into data corresponding to communication specification (such as NFC communication specification) in which the data is transmitted and received to and from the opposing electronic device 102 or can regenerate a data format operated in accordance with each program of the electronic device 101 into a designated data format in the electronic device 101. In obtaining the selected information, the electronic device 101 regenerates a plurality of data into one data for transmission from the electronic device 101 to the opposing electronic device 102, and re-sets (such as compresses) a size of data in the regenerating operation. In obtaining the selected information in a program displayed on the display module 150, the electronic device 101 can obtain the information at the time of selection or obtain simultaneously after a plurality of pieces of information.

In operation 707, the electronic device 101 transmits the obtained data and/or regenerated data to the designated opposing electronic device 102. In transmitting the data, for example, in the NFC communication, the electronic device 101 transmits the data by performing a tagging operation of positioning the opposing electronic device 102 and the NFC module 160 within a designated distance. In an embodiment, the electronic device 101 calls the transmission and reception mode 311 by tagging to the opposing electronic device 102 and transmits the selected information in the transmission and reception mode 311 to the opposing electronic device 102 by tagging again.

As shown in FIG. 7B, in obtaining the selected information in the transmission and reception mode 311, the electronic device 101 performs a security authentication process when the selected information is the secured information, and obtains the selected information according to the security authentication result.

In operation 711, the electronic device 101 calls the transmission and reception mode 311 by performing a designated operation. The electronic device 101 selects the entirety of or a part of information from one or more programs and/or a screen configuration of the programs displayed on the display module 150 and obtains the selected information. The electronic device 101 transmits the selected information to the opposing electronic device 102 in the transmission and reception mode 311 through network communication. In an embodiment, the designated operation of calling the transmission and reception mode in the electronic device 101 can be a tagging operation of positioning the NFC module of the electronic device 101 and the NFC module of the opposing electronic device 102 within a designated distance.

In operation 713, the electronic device 101 selects information to be transmitted to the opposing electronic device 102 from among information displayed on the display module 150 of the electronic device 101. The electronic device 101 selects one or more pieces of information among, web page address data, image data, text data, sound data, link data linked to other contents, and program save data displayed on the display module 150 of the electronic device 101 through the transmission and reception mode 311.

In operation 715, the electronic device 101 detects the selected information as secured information and performs an authentication process for obtaining the secured information. When an input through a designated authentication process is an approved input for changing the secured information, the electronic device 101 obtains the selected information as the secured information in a state where the security is maintained. When receiving the secured information from the opposing electronic device 102, the electronic device 101 performs an identical or similar authentication process to the authentication process performed in the electronic device 101 and uses the secured information according to the authentication process result.

In operation 716, the electronic device 101 obtains the selected information in the transmission and reception mode 311. In obtaining the selected data, the electronic device 101 can regenerate the obtained data into data corresponding to communication specification (such as NFC communication specification) in which the data is transmitted and received to and from the opposing electronic device 102 or can regenerate a data format operated in accordance with each program of the electronic device 101 as a designated data format in the electronic device 101. In obtaining the selected information, the electronic device 101 regenerates a plurality of data into one data for transmission from the electronic device 101 to the opposing electronic device 102 and re-sets (such as compress) a size of data in the regenerating operation. In obtaining the selected information in a program displayed on the display module 150, the electronic device 101 can obtain the information at the time of selection or can obtain simultaneously after a plurality of pieces of information. Although it is described that operation 715 of authenticating security information and operation 716 of resetting information are separately performed, they can be performed together in an operation of obtaining the selected information in the transmission and reception mode 311 of the electronic device 101.

In operation 717, the electronic device 101 transmits the obtained data and/or regenerated data to the designated electronic device 102. In transmitting the data, for example, in case of transmitting in the NFC communication, the electronic device 101 transmits by performing a tagging operation of positioning the opposing electronic device 101 and the NFC module 160 within a designated distance. In an embodiment, the electronic device 101 calls the transmission and reception mode 311 by being tagged to the opposing electronic device 102 and transmits the selected information in the transmission and reception mode 311 to the opposing electronic device 102 by being tagged again. When transmitting the secured information, the electronic device 101 transmits the secured information to the opposing electronic device 102 in designated security applied communication. In an embodiment, an operation of tagging the electronic device 101 to the opposing electronic device 102 can be a pairing operation of connecting network communication through each communication module.

In the above-described detailed description in relation to FIGS. 1 to 7B, the electronic device 101 transmits information obtained through the transmission and reception mode 311 to the opposing electronic device 101 in NFC communication, but the present disclosure is not limited thereto. It is obvious that the data transmission and reception can performed in various wireless communication schemes including Bluetooth (such as BLU communication) Wi-Fi communication, a radio frequency identification (RFID) communication, Infrared data association (IrDA) communication, WiBro communication, and ZigBee communication. According to an embodiment, when the size of information obtained in the transmission and reception mode 311 of the electronic device 101 is greater than a limit size designated to be transmitted to the opposing electronic device 102 in the NFC communication, or when the obtained information is not transmittable to the opposing electronic device 102 in the NFC communication, the electronic device 101 can determine another communication (such as BLU communication) connected or connectable to the opposing electronic device 102, and transmit the obtained information in the determined BLU communication.

An operation method of an electronic device can include an operation of selecting first information included in a first program and second information included in a second program, an operation of converting the selected first and second information according to a transmission mode of short range communication and generating third and fourth information, and an operation of transmitting the third and fourth information to an opposing electronic device by using the short range communication.

According to various embodiments, the operation of generating the third and fourth information can apply one or more conditions of a name change, a data format change, and a command structure change for one or more pieces of the first and second information.

The operation of transmitting can further include an operation of performing a designated operation when the designated operation of inputting to the electronic device is detected. According to an embodiment, the designated operation can be a tagging operation of positioning the electronic device and the opposing electronic device within a designated distance. The short range communication can be one or more of NFC communication, Bluetooth communication, Wi-Fi communication, RFID communication, IrDA communication, WiBro communication, and ZigBee communication.

The operation of generating third and fourth information can further include performing an authentication process and obtaining the security applied information according to a result of the authentication process and/or generating fifth information to which security is applied on the basis of the acquired security applied information, when one or more pieces of the first and second information is information to which security is applied. The first or second information can be one or more of web page address data, image data, sound data, save data of a program, text data, identification code of a first or second program, link data linked one or more contents.

When the first or second information is about weather and time, the electronic device can include instructions set to change weather and time of the opposing electronic device that receives information on the weather and time. An operation method of an electronic device includes an operation of obtaining first information included in a first program, an operation of obtaining second information included in a second program, an operation of converting the obtained first and second information according to a transmission mode of short range communication and generating third and fourth information, and an operation of transmitting the third and fourth information to the opposing electronic device by using short range communication.

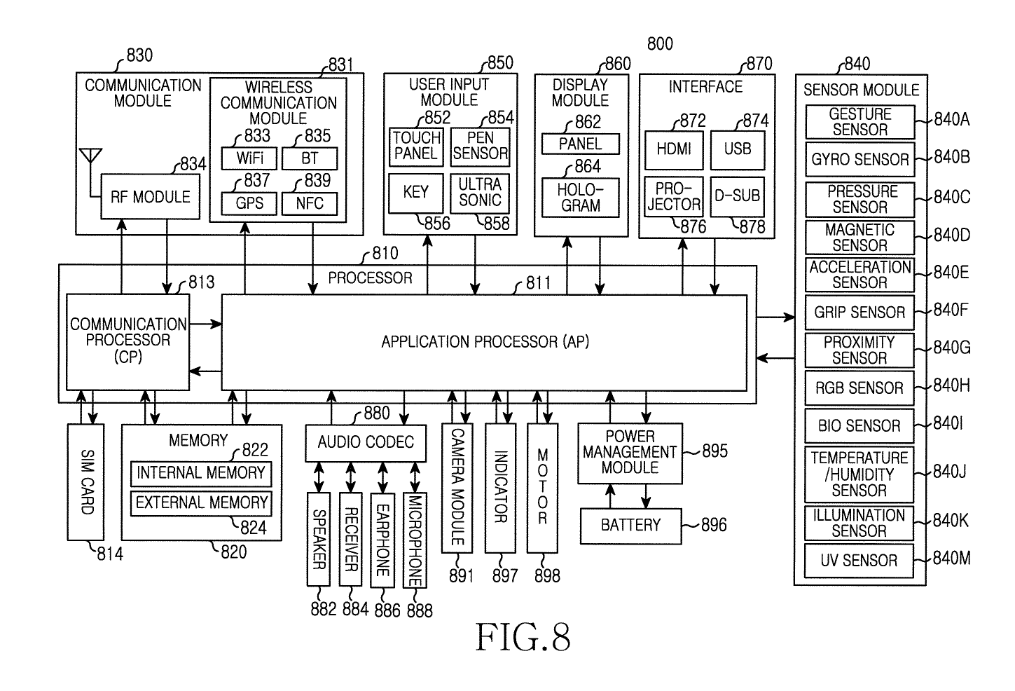

FIG. 8 is an example block diagram of hardware 800 according to this disclosure.

The hardware 800, for example, can be the entirety of or a part of an electronic device 101 illustrated in FIG. 1. Referring to FIG. 8, the hardware 800 can include can include at least one processor 810, a subscriber identification module (SIM) card 814, a memory 820, a communication module 830, a sensor module 840, a user input module 850, a display module 860, an interface 870, an audio codec 880, a camera module 891, a power management module 895, a battery 896, an indicator 897, or a motor 898.

The processor 810 (such as the processor 120) includes one or more application processors (APs) 811 or one or more communication processors (CPs) 813. The processor 810 can be, for example, the processor 120 illustrated in FIG. 1. In FIG. 8, the AP 811 and the CP 813 are included in the processor 810, but the AP 811 and the CP 813 can be respectively included in different IC packages. In an embodiment, the AP 811 and the CP 813 can be included in one IC package.

The AP 811 drives an operating system or an application to control a plurality of software or hardware elements connected thereto, and process and operate various data including multimedia data. The AP 811 can be implemented with, for example, a system on chip (SoC). According to an embodiment, the processor 810 can further include a graphic processing unit (GPU).

The CP 813 manages data links in communication between the electronic device (such as the electronic device 101) including the hardware 800 and other electronic devices connected in a network and performs a function of converting a communication protocol. The CP 813 can be implemented with an SoC. In an embodiment, the CP 813 can perform at least a part of multimedia control function. The CP 813 can perform identification and authentication on a terminal in a communication network by using a subscriber identification module (such as SIM card 814). In addition, the CP 813 can provide a user with services such as a voice call, a video call, text message, or packet data service.

Furthermore, the CP 813 controls data transmission and reception of the communication module 830. In FIG. 8, elements such as the CP 813, the power management module 895, and the memory 820 are separately illustrated. However, according to an embodiment, the AP 811 can be implemented to include at least a part (such as the CP 813) of the above-described elements.

In an embodiment, the AP 811 or the CP 813 loads, on a volatile memory, commands or data received from at least one of a nonvolatile memory or other elements respectively connected thereto and process them. Furthermore, the AP 811 or the CP 813 stores, in the nonvolatile memory, data received from or created by at least one of other elements.

The SIM card 814 is a card that a subscriber identification module is implemented and is inserted into a slot formed at a specific position of the electronic device. The SIM card 814 includes unique identification information (such as integrated circuit card identifier (ICCID)) or subscriber information (such as international mobile subscriber identity (IMSI)).

The memory 820 includes an internal memory 822 or an external memory 824. The memory 820 can be, for example, the memory 130 illustrated in FIG. 1. The internal memory 822 can include at least one selected from, for example, a volatile memory (such as a dynamic RAM (DRAM), static RAM (SRAM), synchronous dynamic RAM (SDRAM) and the like) or a nonvolatile memory (such as a one time programmable ROM (OTROM), programmable ROM (PROM), erasable and programmable ROM (EPROM), electrically erasable and programmable ROM (EEPROM), mask ROM, flash ROM, NAND flash memory. NOR flash memory and the like). In an embodiment, the internal memory 822 can have a solid state drive (SSD) type. The external memory 824 can further include a flash drive, for example, compact flash (CF), secure digital (SD), micro-secure digital (micro-SD), mini secure digital (mini-SD), extreme digital (xD), or a memory stick.

The communication module 830 can include a wireless communication module 831 or a radio-frequency (RF) module 834. The communication module 830 can be, for example, the communication module 170 illustrated in FIG. 1. The wireless communication module 831 can include, for example, a Wi-Fi module 833, a BT module 835, a GPS module 837, or an NFC module 839. For example, the wireless communication module 831 can provide a wireless communication function using radio frequency. Additionally or alternatively, the wireless communication module 831 can include a network interface (such as a LAN card) or a modem for connecting the hardware 800 to a network (such as the Internet, LAN, WAN, telecommunication network, cellular network, satellite network or plain old telephone service (POTS)).

The RF module 834 performs data transmission and reception, for example, transmission and reception of an RF signal or a called electronic signal. Although not shown in the drawing, the RF module 834 includes, for example, a transceiver, a pluggable authentication module (PAM), a frequency filter, or a low-noise amplifier (LNA). Furthermore, the RF module 834 can further include a component for transmitting and receiving an electromagnetic wave in a free space in a wireless communication, for example, conductor or conducting wires.

The sensor module 840 can include at least one of, for example, a gesture sensor 840A, gyro sensor 840B, atmospheric pressure sensor 840C, magnetic sensor, 840D, acceleration sensor 840E, grip sensor 840F, proximity sensor 840G, RGB sensor 840H, biometric sensor 840I, temperature/humidity sensor 840J or ambient light sensor 840K, and UV sensor 840M. The sensor module 840 measures a physical quantity or detects an operating state of the electronic device and converts the measured or detected information into an electrical signal. Additionally or alternatively, the sensor module 840 can include, for example, an e-nose sensor, an electromyography (EMG) sensor, an electroencephalogram (EEG) sensor, an electrocardiogram (ECG) sensor or a fingerprint sensor. The sensor module 840 can further include a control circuit for controlling at least one sensor therein.

The user input module 850 can include a touch panel 852, a (digital) pen sensor 854, a key 856, or an ultrasonic input device 858. The user input module 850 can be, for example, the input and output interface 140 illustrated in FIG. 1. The touch panel 852 can recognize a touch input in at least one selected from capacitive, pressure-sensitive, infra-red ray, and surface acoustic wave type. In addition, the touch panel 852 can further include a controller. In case of capacitive type, not only direct touch but also proximity recognition is possible. The touch panel 852 can further include a tactile layer. In this case, the touch panel 852 provides a tactile reaction to the user.

The (digital) pen sensor 854 can be implemented by using, for example, a method identical or similar to receiving user's touch input or a separate recognition sheet. The key 856 can include, for example, a keypad or a touch key. The ultrasonic input device 858 can be a device that is able to detect a sound wave through a microphone (such as microphone 888) and check data in the terminal through a pen generating an ultrasonic wave signal, and can be a device that wireless awareness is possible. In an embodiment, the hardware 800 can receive a user input from an external device (such as a network, computer or server) by using the communication module 830.

The display module 860 can include a panel 862 and a hologram device 864. The display module 860 can be, for example, a display module 150 illustrated in FIG. 1. The panel 862 can be, for example, a liquid crystal display or an active-matrix organic light-emitting diode (AMOLED). The panel 862 can be implemented as, for example, flexible, transparent or wearable. The panel 862 can be configured as one module with the touch panel 852. The hologram device 864 can show a stereoscopic image in the air by using interference of light. In an embodiment, the display module 860 can further include a control circuit for controlling the panel 862 and the hologram device 864.

The interface 870 can include, for example, a high-definition multimedia interface (HDMI), 872, a universal serial bus (USB) 874, a projector 876 or a D-subminiature (D-sub) 878. Additionally or alternatively, the interface 870 can include, for example, a secure digital (SD) card/multimedia card (MMC) interface, or an (IrDA) interface.

The audio codec 880 can convert sound into an electrical signal or vice versa. The audio codec 880 can convert sound information input from or output to, for example, a speaker 882, receiver 884, earphone 886 or microphone 888.

The camera module 891 is a device for capturing a still image or a video, and can include at least one image sensor (such as the front side sensor or the rear side sensor), an image signal processor (ISP), or a flash LED.

The power management module 895 can manage power of the hardware 800. The power management module 895 can include, for example, a power management integrated circuit (PMIC), a charger integrated circuit, or a battery or a fuel gauge.

The PMIC can be embedded, for example, in an IC or inside a SoC. A charging scheme can be divided into a wireless and wired scheme. The charging IC can charge the battery and block inflow of over-voltage or over-current from a charger. In an embodiment, the charging IC can include a charging IC for at least one of a wired charging scheme or a wireless charging scheme. As with the wireless charging scheme, for example, there can be a magnetic resonance scheme, inductive coupling scheme, or microwave scheme. An additional circuit, for example, a coil loop, resonance circuit, rectifier, or the like, can be further included for wireless charging.

The battery gauge measures, for example, a remaining amount of the battery 896, voltage, current or temperature while in charging. The battery 896 stores and/or generates electricity and supply power, and can be a rechargeable battery.

The indicator 897 can display a specific state of the hardware 800 or a part thereof (such as the AP 811), for example, a booting state, messaging state or charging state, and the like The motor 898 can convert an electrical signal into a mechanical vibration. The MCU can control the sensor module 840.

The hardware 800 can include a processing device (such as GPU) for supporting a mobile TV. The processing device for supporting the mobile TV can process media data complying with specification such as digital multimedia broadcasting (DMB), digital video broadcasting (DVB), or media flow, and the like. Each of the above-described elements can be configured with one or more components and a name of a corresponding element can vary according to a kind of electronic device. An electronic device according to various embodiments can be configured with at least one element among the above-described elements and some elements can be omitted or additional other elements can be further included. Furthermore, some of elements of an electronic device according to various embodiments can be combined to be one entity and perform the same functions as those of corresponding elements before the combination.

Various exemplary embodiments for describing the present disclosure can be performed by using one or more programs included in the memory 130 of the electronic device 101, or can be directly controlled by a processor (such as the processor 120). In addition, the exemplary embodiments can also be controlled by using one or more control modules (such as the data processing module 105). The data processing module 105 can be controlled by the processor.

The present disclosure can improve inconvenience that can be caused by a complicated process of obtaining data operated in one or more programs and transmitting the obtained data to an opposing electronic device and repeating the operations.

Methods according to embodiments described in claims and/or specification can be implemented with software, hardware, or a combination thereof.

In case of implementing with software, a computer readable recording medium storing one or more programs (software modules) can be provided. The one or more programs stored in the computer readable recording medium are configured to be executable by one or more processors in the electronic device. The one or more programs include commands for allowing the electronic device to execute the method according to embodiments described in claims and/or specification.

Such a program (software module, software) can be stored in a random access memory, a nonvolatile memory including a flash memory, a ROM, EEPROM, a magnetic disk storage device, a CD-ROM, a digital versatile disc, or another type of optical storage device, a magnetic cassette. Alternatively, the program can also be stored in a memory formed of combination of a part of or the entirety of them. Alternatively, each configuration memory can be included in plurality.

The program can also be stored in a storage device attachable to the electronic device and accessible through a communication network such as the internet, an intranet, a LAN, a WAN, a storage area network (SAN), or a communication network formed of combination thereof. This storage device can be accessed by the electronic device through an external port. Furthermore, a separate storage device on the communication network can be accessed by a mobile electronic device.

A term “module” used herein can mean, for example, a unit including a combination of one or two or more of hardware, software, or firmware. A “module” can be interchangeably used with a term, for example, a unit, logic, logical block, component, or circuit. A “module” can be a minimum or a part of unit of a component configured into one. A “module” can be a minimum or a part of unit performing one or more functions. A “module” can be implemented mechanically or electronically. For example, a “module” according to the specification can include at least one selected from an application-specific integrated circuit (ASIC) chip, field-programmable gate arrays (FPGAs), and programmable-logic device which perform certain operations and are already known or to be developed.

In an embodiment, at least a part of devices (such as modules or functions thereof) or methods (such as operations) according to various embodiments can be implemented as instructions stored in a computer-readable storage medium in the form of a programming module. In the case where the instructions are performed by at least one processor (such as the processor 810), the at least one processor can perform functions corresponding to the instructions. The computer-readable storage medium can be, for example, a memory 820. At least a part of the programming module can be implemented (such as executed) by the processor 810. At least a part of the programming module can include, for example, a module, application, routine, sets of instructions, or process for performing at least one function.

The programming module according to various embodiments of the present disclosure can include at least one of the above-mentioned elements, or some elements can be omitted or other additional elements can be added. Operations performed by the module, the programming module or the other elements can be performed in a sequential, parallel, iterative or heuristic way. Furthermore, some operations can be performed in another order or can be omitted, or other operations can be added.

The computer-readable storage medium can include a magnetic medium such as a hard disk, a floppy disk and a magnetic tape, an optical medium such as a compact disk read only memory (CD-ROM) and a digital versatile disc (DVD), a magneto-optical medium such as a floptical disk, and a hardware device configured to store and execute program instructions (such as programming module), such as a read only memory (RAM), a random access memory (RAM) and a flash memory. The program instructions can include machine language codes made by compilers and high-level language codes that can be executed by computers using interpreters. The above-mentioned hardware can be configured to be operated as one or more software modules for performing operations of various embodiments of the present disclosure and vice versa.

While the disclosure has been shown and described with reference to certain preferred embodiments thereof, it will be understood by those skilled in the art that various changes in form and details can be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method of an electronic device, the method comprising:
selecting first information included in a first program and second information included in a second program;
generating third and fourth information respectively by converting the selected first and second information according to a transmission mode of a short range communication; and
transmitting the third and fourth information to an opposing electronic device using the short range communication.

2. The method of claim 1, wherein generating the third and fourth information comprises applying one or more conditions of a name change, a data format change, and a command structure change to one or more pieces of the first and second information.

3. The method of claim 1, wherein transmitting is performed when a designated operation of inputting to the electronic device is detected.

4. The method of claim 3, wherein the designated operation includes a tagging operation that positions the electronic device and the opponent device within a designated distance.

5. The method of claim 1, wherein the short range communication is one or more of a near field communication (NFC), a Bluetooth communication, a Wi-Fi communication, a radio-frequency identification (RFID) communication, an Infrared Data Association (IrDA) communication, a WiBro communication, and a ZigBee communication.

6. The method of claim 1, wherein generating the third and fourth information further comprises, when one or more pieces of the first and second information are security-applied, performing an authentication process and obtaining the security applied information according to the authentication result and generating fifth information to which security is applied on the basis of the obtained security-applied information.

7. The method of claim 1, wherein the first and second information is selected from one or more of web page address data, image data, sound data, program dace data, text data, an identification code of the first or second program, and link data linked to one or more contents.

8. The method of claim 1, wherein, when the first or second information is information about weather and time, the first or the second information includes instructions set to change weather and time information of the opposing electronic device that receives the information about the weather and time.

9. A method of an electronic device, comprising:
obtaining first information included in a first program;
obtaining second information included in a second program;
converting the obtained first and second information according to a transmission mode of short range communication and generating third and fourth information, respectively; and
transmitting the third and fourth information to an opposing electronic device using the short range communication.

10. An electronic device comprising:
a memory comprising one or more pieces of obtained information;
a communication module configured to transmit the obtained information;
a processor configured to:
select first information included in a first program and second information included in a second program,
generate third and fourth information respectively by converting the selected first and second information according to a transmission mode of short range communication, and
transmit the third and fourth information to an opposing electronic device using the short range communication.

11. The electronic device of claim 10, wherein the processor is configured to generates the third and fourth information by applying one or more conditions of a name change, a data format change, and a command structure change to one or more pieces of the first and second information.

12. The electronic device of claim 10, wherein the processor is configured to transmit the third and fourth information when a designated operation of inputting to the electronic device is detected.

13. The electronic device of claim 12, wherein the processor is configured to set, as the designated operation, a tagging operation that positions the electronic device and the opponent device within a designated distance.

14. The electronic device of claim 10, wherein the processor is configured to transmit the third and fourth information selected from one or more of near field communication (NFC), Bluetooth communication, Wi-Fi communication, radio-frequency identification (RFID) communication, Infrared Data Association (IrDA) communication, WiBro communication, and ZigBee communication.

15. The electronic device of claim 10, wherein, when one or more pieces of the first and second information are security-applied, the processor is configured to perform an authentication process, obtain the security applied information according to the authentication result, and generate fifth information to which security is applied on the basis of the obtained security-applied information.

16. The electronic device of claim 10, wherein the processor is configured to allow the first and second information to select one or more of web page address data, image data, sound data, program dace data, text data, an identification code of the first or second program, link data linked to one or more contents.

17. The electronic device of claim 10, wherein, when the first or second information is information about weather and time, the processor comprises instructions set to change weather and time information of the opposing electronic device that receives the information about weather and time.

18. The method of claim 1, wherein the electronic device includes at least one of a smartphone, a tablet personal computer (PC), a mobile phone, a video telephone, an electronic book reader, a desktop PC, a laptop PC, a network computer, a personal digital assistant (PDA), a portable multimedia players (PMP), an MP3 player, a mobile medical device, a camera, and a wearable device.

19. The method of claim 9, wherein the electronic device includes at least one of a smartphone, a tablet personal computer (PC), a mobile phone, a video telephone, an electronic book reader, a desktop PC, a laptop PC, a network computer, a personal digital assistant (PDA), a portable multimedia players (PMP), an MP3 player, a mobile medical device, a camera, and a wearable device.

20. The electronic device of claim 10, wherein the electronic device includes at least one of a smartphone, a tablet personal computer (PC), a mobile phone, a video telephone, an electronic book reader, a desktop PC, a laptop PC, a network computer, a personal digital assistant (PDA), a portable multimedia players (PMP), an MP3 player, a mobile medical device, a camera, and a wearable device.
